(19) United States
(12) Patent Application Publication
(10) Pub. No.: US 2025/0164346 A1
(43) Pub. Date: May 22, 2025

(54) SYSTEM AND METHOD FOR MEASURING CREEP OF HYDRO-GENERATOR BY USING IMAGE MONITORING

(71) Applicant: CHINA YANGTZE POWER CO., LTD., Wuhan, Hubei (CN)

(72) Inventors: Zhezhi CHEN, Wuhan, Hubei (CN); Tengqing XIONG, Wuhan, Hubei (CN); Chuhui LI, Wuhan, Hubei (CN); Litao JIA, Wuhan, Hubei (CN); Sai YANG, Wuhan, Hubei (CN); Yihua ZHANG, Wuhan, Hubei (CN); Xiaodan TANG, Wuhan, Hubei (CN); Hua HUANG, Wuhan, Hubei (CN); Yongjun WANG, Wuhan, Hubei (CN); Jun LUAN, Wuhan, Hubei (CN); Shun ZENG, Wuhan, Hubei (CN); Zhongchang WANG, Wuhan, Hubei (CN)

(73) Assignee: CHINA YANGTZE POWER CO., LTD., Wuhan, Hubei (CN)

(21) Appl. No.: 18/841,632

(22) PCT Filed: Feb. 28, 2023
(86) PCT No.: PCT/CN2023/078715

§ 371 Date: Aug. 26, 2024

(30) Foreign Application Priority Data
Mar. 9, 2022 (CN) 202210232476.2

(51) Int. Cl. G01M 11/08

(52) U.S. Cl. CPC G01M 11/081

(57) ABSTRACT

A system and a method for measuring creep of a hydro-generator are provided. In the system, circle of “sawtooth waveform” ribbon is arranged around an outer wall of a main shaft of a hydro-turbine, a “sawtooth waveform” of the ribbon is formed by arranging isosceles right triangles, a hypotenuse of the isosceles right triangle forms a straight line segment, the isosceles right triangle is painted with a color code, a camera is arranged directly opposite to the main shaft of the hydro-turbine, and the camera takes an image of the ribbon and images on an imaging plane at a back end. The main shaft of the hydro-turbine is continuously photographed and sampled with an image, the image processing terminal extracts feature quantities on a reference image and a current image, calculates a creep angle of a set, and sends out an alarm signal when it reaches an alarm value.

### FIELD

The present invention relates to the technical field of hydro-turbine monitoring, and particularly to a system and a method for measuring creep of a hydro-generator by using image monitoring.

### BACKGROUND

When a hydro-generator set is in a halt mode, a pressure brought by a high upstream water level is borne through closure of guide vanes. In an actual operation process, due to a large number of the guide vanes, the guide vanes will inevitably be corroded or damaged under long-term water flow erosion, which will lead to an increase of a gap between metal joint surfaces. The water flow can enter a rotating wheel through the gaps of the guide vanes. When water leakage of the guide vanes increases to a certain extent, the water flow will impact the rotating wheel of the hydro-turbine, causing a rotating part of the set to rotate slowly, that is, the set creeps. Because creep motion of a hydro-generator set is very slow, it is difficult for human eyes to distinguish in a short time, but the creep motion does great harm to a bearing of the set. After the set is halted, an oil film between bearing bush gaps gradually disappears. At this time, the set creeps, and a bearing bush is in a dry friction state. If a creep time is too long, it will easily lead to abnormal wear of a contact surface, which will increase a friction coefficient. This will burn the bearing bush when the set is running, which will result in accidental shutdown of the set due to load rejection, and thus causing a great damage to the running equipment and a power grid.

At present, there are two main ways to detect the creep of a main shaft of the hydro-generator set: the first way is mechanical friction detection. The mechanical friction way uses a principle of a mechanical friction to transfer displacement. After the set is halted, a monitor sends out a command of putting in a creep device, an electromagnetic valve acts, a low-pressure gas enters an inputting cylinder, and a friction wheel is pushed out of a detection device and clings to a surface of the main shaft of the set. When the set creeps, the friction wheel deflects with the set. When a deflection amount reaches a certain angle, a microswitch in the device is triggered and an alarm signal is sent out. The advantage of the detection way is that sensitivity is high, but the disadvantage is that a mechanical structure is complex. It is necessary to rub a backup wheel to reliably contact with a surface of the main shaft of the set and transmit a creep rotation amount, and to ensure that the detection device can be reliably withdrawn before the set rotates. In use, it is easy to cause failures such as action jamming, wheel wear and spring failure, etc.

The second way is non-contact. The principle is that a toothed disc is installed on the main shaft of the set. Because the creep is actually a rotation amount, when the set creeps, a gear is driven to move the corresponding displacement, and at the same time, a photoelectric sensing probe arranged at a corresponding position of the toothed disc will receive a signal. When a movement displacement amount of the toothed disc exceeds a tooth pitch, an output level signal of a speed measuring sensor jumps to generate a rising edge signal or a falling edge signal. After a monitoring instrument recognizes and processes, a creep alarm signal is sent out to a monitoring system. The disadvantage of this kind of creep device is that, when a probe is facing an intersection position of a convex groove and a concave groove of a toothed belt, it is easy to jump the level signal and send out the creep signal of the set by mistake. Secondly, because the toothed belt is installed on the rotating part of the set, a risk of loosening the toothed belt is high under the action of a centrifugal force.

### SUMMARY

A technical problem to be solved according to the present invention is to provide a system and a method for measuring creep of a hydro-generator by image monitoring. By using image monitoring equipment fixedly installed on a peripheral wall of a main shaft of a hydro-turbine, the main shaft of the hydro-turbine is continuously photographed and sampled with an image, data are fed back to an image processing terminal, and the image processing terminal automatically extracts feature quantities on a reference image and a current image, and then calculates a creep angle of a set by using a designated algorithm, and sends out an alarm signal when the creep angle reaches an alarm value.

The technical solution adopted by the present invention is:

A system for measuring creep of a hydro-generator by using image monitoring, a circle of “sawtooth waveform” ribbon is arranged around an outer wall of a main shaft of a hydro-turbine, a “sawtooth waveform” of the ribbon is formed by arranging isosceles right triangles, a hypotenuse of the isosceles right triangle forms a straight line segment, right angles of the adjacent isosceles right triangles are respectively on an upper side and a lower side of the hypotenuse, the isosceles right triangle is painted with a color code, a camera is arranged directly opposite to the main shaft of the hydro-turbine, a horizontal center of the camera is flush with the straight line segment formed by the hypotenuse of the isosceles right triangle, the camera takes an image of the ribbon and images on an imaging plane at a back end, and whether the hydro-generator creeps is judged according to a vertical height change of the ribbon image subsequently taken at a specific image pickup position and when the main shaft of the hydro-turbine stops.

Two adjacent isosceles right triangles form a period, and the ribbon consists of n periods, which are connected end to end.

In the case of a limited size of an imaging plane, division of a number of sawtooth waves on a ribbon is mainly affected by three factors: image resolution, measurement accuracy and a vertical height of the sawtooth waves, not exceeding a width of a camera. If the number of the sawtooth waves is too small, under a condition of a limited imaging size, a ratio of an actual graphic size to an imaging size will inevitably increases, and the measurement accuracy decreases, which cannot accurately reflect a small rotation amount of the set. If the number of the sawtooth waves is too large, the number of the images collected and processed by the image processing equipment in a unit time is required to increase, which requires a high image collection and processing ability. Secondly, the more the sawtooth waves are, the more difficult it is to install on site. Therefore, according to the characteristics that a frame rate of the images collected by the image monitoring equipment is very high at present and a rotating speed of the hydro-generator set is very small at the beginning of creep, a period of the images collected by the image monitoring equipment before and after the creep will not exceed ¼ by default, and the number of the sawtooth waves in the ribbon is hereby calculated and a creep alarm logic of the set is designed.

A national standard GB 11805-2008 Basic Specifications of Automatic Control Components (Devices) and Their Related System for Hydroturbine-generating Sets requires that a creep detection device shall output a pair of fault contacts at a rotating angle of 1.5°-2° when the main shaft rotates due to the water leakage in the guide vanes when the set is in the halt mode, so that the creep detection device can reliably detect when the set rotates at the rotating angle of 1.5°-2° in a ¼ period, and send an alarm signal, therefore, a central angle θ corresponding to the ¼ period shall be more than or equal to 2°, then

$$\frac{90 °}{n} \geq 2 \to n \leq 45 .$$

A radius of the main shaft of the hydro-turbine is defined as R, a vertical distance from an imaging lens on the camera to a circular section of the main shaft, that is, an object distance, is F, a distance from the imaging lens to the imaging plane, that is, an image distance, is f, ½ of a vertical maximum length of the imaging plane is h, a width of the camera is Z, according to an image forming principle:

$$\frac{F}{f} = \frac{Z}{h} \to Z = \frac{Fh}{f}$$

wherein a circumference L of the main shaft of the hydro-turbine can be expressed as: L=2πR
a circular arc length L₀ corresponding to one degree of a central angle of the main shaft of the hydro-turbine can be expressed as:

$${L}_{0} = \frac{2 π R}{36 {0}^{0}}$$

the ribbon on the main shaft of the hydro-turbine is composed of the adjacent isosceles right triangles with n periods, so a circular arc length L₁ corresponding to a ¼ period is:

$${L}_{1} = \frac{L}{4 n} = \frac{π R}{2 n}$$

a vertical height H of the isosceles right triangle obtained according to a geometric relationship is:

$$H = {L}_{1} = \frac{π R}{2 n}$$

a central angle θ corresponding to the ¼ period is:

$$θ = \frac{{L}_{1}}{{L}_{0}} = \frac{{90}^{0}}{n} ;$$

according to the requirement that the vertical height H of an isosceles right triangle cannot exceed the with Z of the camera, it is concluded that:

$$H \leq Z \to \frac{π R}{2 n} \leq \frac{Fh}{f}$$

There is

$$F \geq \frac{π Rh}{2 nf} , \frac{h}{f}$$

is determined by the characteristics of the selected camera. Therefore, when the camera is selected, the vertical distance from the imaging lens to the circular section of the main shaft of the hydro-turbine should be not less than

$$\frac{π Rh}{2 nf} ,$$

so as to meet the requirement that the image can display the ribbon completely.

The system for measuring the creep of the hydro-generator by using the image monitoring, the isosceles right triangle on the ribbon takes a vertical line with a vertex of the right angle downward as a symmetry line, and the isosceles triangles on both sides of the symmetry line are respectively painted with two different color codes.

A measuring method using the system for measuring the creep of the hydro-generator by using the image monitoring, comprising the measuring steps of:
step 1, after halting a set, taking the image of the ribbon by the camera and imaging on the imaging plane at the back end, and then continuing to image the ribbon according to a frame rate of image monitoring equipment connected to the camera, and firstly carrying out basic calculation:
a circumference L of the main shaft of the hydro-turbine being expressed as: L=2πR
a circular arc length L₀ corresponding to one degree of a central angle of the main shaft of the hydro-turbine being expressed as:

$${L}_{0} = \frac{2 π R}{36 {0}^{0}}$$

the ribbon on the main shaft of the hydro-turbine being composed of the adjacent isosceles right triangles with n periods, so a circular arc length L₁ corresponding to a ¼ period being:

$${L}_{1} = \frac{L}{4 n} = \frac{π R}{2 n}$$

a vertical height H of the isosceles right triangle obtained according to a geometric relationship being:

$$H = {L}_{1} = \frac{π R}{2 n}$$

a central angle θ corresponding to the ¼ period being:

$$θ = \frac{{L}_{1}}{{L}_{0}} = \frac{90 °}{n} ;$$

step 2, defining an imaging time when the set is halted as a time TO, and a subsequent imaging time as a time T1, a corresponding y-axis direction height of the image at the time TO at the image pickup position being H0, the corresponding y-axis direction height on the main shaft of the hydro-turbine at the image pickup position at the time TO being H0′, the corresponding y-axis direction height of the image at the time T1 at the image pickup position being H1, and the corresponding y-axis direction height on the main shaft of the hydro-turbine at the image pickup position at the time T1 being H1′, according to an imaging principle:

$$\frac{F}{f} = \frac{H {0}^{′}}{H 0} = \frac{H {1}^{′}}{H 1}$$

obtaining

$$H {0}^{′} = \frac{F}{f} \times H 0 , H {1}^{′} = \frac{F}{f} \times H 1 ;$$

an arc length corresponding to a rotating central angle of the main shaft of the hydro-turbine being ∇L from the time T0 to the time T1, then:
entering into step 3 when the color codes of the image picked up at the image pickup position of the image plane at the time TO and the time T1 being the same;
entering into step 4 when the color codes of the image picked up at the image pickup position of the image plane at the time TO and the time T1 being different, and directions being different; and
entering into step 5 when the color codes of the image picked up at the image pickup position of the image plane at the time TO and the time T1 being different, but the directions being the same;
step 3, when the color codes of the image picked up at the image pickup position of the image plane at the time TO and the time T1 being the same,

$$∇ L = \vert H {1}^{′} - H {0}^{′} \vert ;$$

calculating a rotating angle ∇θ of the hydro-turbine according to the circular arc length L₀ corresponding to one degree of the central angle of the main shaft of the hydro-turbine:

$$∇ θ = \frac{∇ L}{{L}_{0}} = \frac{\vert H {1}^{′} - H {0}^{′} \vert}{π R} \times 180 ° entering into step 6 ;$$

step 4, when the color codes of the image picked up at the image pickup position of the image plane at the time TO and the time T1 being different, and the directions being different,

$$∇ L = H {0}^{′} + H {1}^{′} ;$$

calculating the rotating angle ∇θ of the hydro-turbine according to the circular arc length L₀ corresponding to one degree of the central angle of the main shaft of the hydro-turbine:

$$∇ θ = \frac{∇ L}{{L}_{0}} = \frac{H {0}^{′} - H {1}^{′}}{π R} \times 180 ° entering into step 6 ;$$

step 5, when the color codes of the image picked up at the image pickup position of the image plane at the time TO and the time T1 being different, and the directions being different,

$$∇ L = 2 H - H {0}^{′} - H {1}^{′} ;$$

calculating the rotating angle ∇θ of the hydro-turbine according to the circular arc length L₀ corresponding to one degree of the central angle of the main shaft of the hydro-turbine:

$$∇ θ = \frac{∇ L}{{L}_{0}} = \frac{2 H - H {0}^{′} - H {1}^{′}}{π R} \times 180 ° entering into step 6 ;$$

step 6, comparing ∇θ with a set creep allowable threshold, and if exceeding the threshold, then outputting a creep alarm of the set.

The system and the method for measuring the creep of the hydro-generator by image monitoring provided by the present invention have the following beneficial effects.
1. By installing a circle of sawtooth waveform ribbon on the main shaft of the hydro-turbine, measurement and alarm of a creep angle of the hydro-generator are innovatively realized by using an image forming principle of the lens and a graphic algorithm.
2. The algorithm provided by the present invention can detect a rotating angle of the set in a ¼ period of the ribbon, and meets the requirements of the set creep alarm angle specified in the national standard (GB 11805-2008).
3. The image monitoring equipment installed in most hydropower stations at present is utilized, and there is no need to add additional equipment and electrical circuits, only a set of set creep detection algorithm is needed in the current image monitoring equipment, which is easy to realize and maintain.
4. In the present invention, the creep detection and alarm of the set are realized by software, and there is no problem of failure in throwing and retreating.
5. The present invention realizes a linkage function of the set creep alarm and the image monitoring camera. When the set sends out the creep alarm signal, a real-time image of the main shaft of the hydro-turbine of the unit is immediately pushed out on a monitoring screen of a duty officer, which is beneficial for the duty officer to timely and accurately judge whether the set creeps and deal with the creep.

### BRIEF DESCRIPTION OF THE DRAWINGS

The present invention will be further described with reference to the drawings and the embodiments:

FIG. 1 is a schematic structural diagram of a creep detection system according to the present invention;

FIG. 2 is a schematic unfolding diagram of a ribbon on a main shaft of a hydro-turbine according to the present invention;

FIG. 3 is a schematic diagram of characteristic images of the hydro-turbine before and after creep in a same color code according to the present invention;

FIG. 4 is a schematic diagram showing that the characteristic images of the hydro-turbine before and after the creep are not in the same color code and have different directions according to the present invention; and

FIG. 5 is a schematic diagram showing that the characteristic images of the hydro-turbine before and after the creep are not in the same color scale but in the same direction according to the present invention.

In the picture: 1 refers to main shaft of hydro-turbine 1, 2 refers to camera, 3 refers to imaging plane.

### DETAILED DESCRIPTION

The technical solution of the present invention will be described hereinafter in conjunction with the drawings and the embodiments.

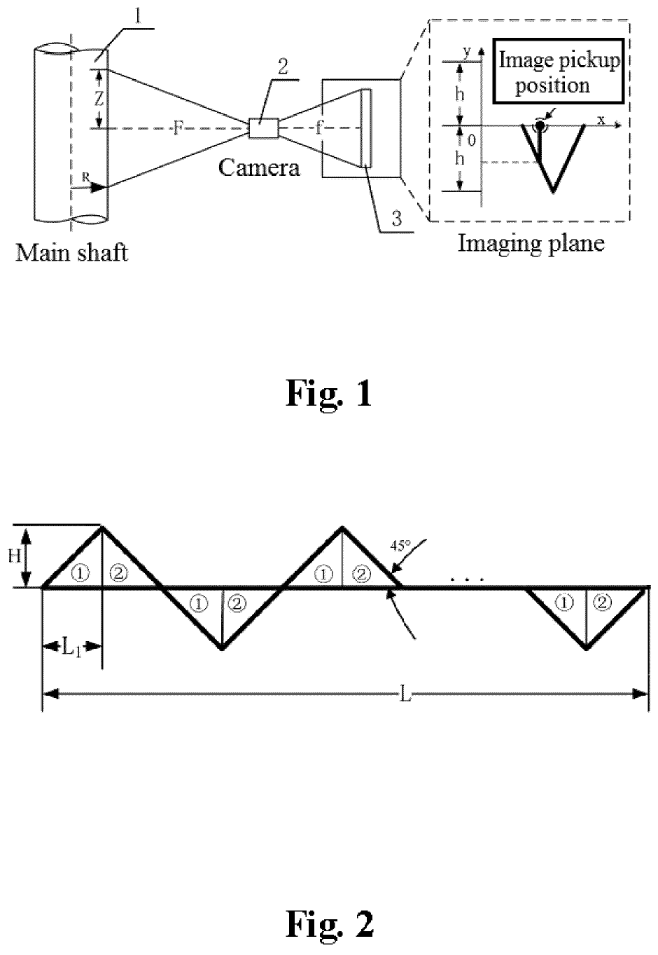

As shown in FIG. 1, a system for measuring creep of a hydro-generator by using image monitoring, wherein a circle of “sawtooth waveform” ribbon is arranged around an outer wall of a main shaft 1 of a hydro-turbine, a “sawtooth waveform” of the ribbon is formed by arranging isosceles right triangles, a hypotenuse of the isosceles right triangle forms a straight line segment, right angles of the adjacent isosceles right triangles are respectively on an upper side and a lower side of the hypotenuse, the isosceles right triangle is painted with a color code, a camera 2 is arranged directly opposite to the main shaft 1 of the hydro-turbine, a horizontal center of the camera 2 is flush with the straight line segment formed by the hypotenuse of the isosceles right triangle, the camera 2 takes an image of the ribbon and images on an imaging plane 3 at a back end, and whether the hydro-generator creeps is judged according to a vertical height change of the ribbon image subsequently taken at a specific image pickup position and when the main shaft 1 of the hydro-turbine stops.

The camera should be installed firmly and reliably, and position deviation should not occur even in a harsh vibration environment. Secondly, an installation position of the camera should completely photograph the ribbon of the main shaft of the hydro-turbine and display the photographed image on the imaging plane, as shown in FIG. 1, a horizontal center line of the ribbon and a horizontal center line of the camera lens are in the same plane.

Because the surface of the main shaft of the hydro-turbine is painted with a uniform color anti-corrosive paint, it is not conducive to recognize and process the image. In order to facilitate image processing and measure a rotating angle of the set, the circle of sawtooth waveform ribbon is arranged on the main shaft of the hydro-turbine. Image monitoring equipment can obtain a change size of a feature quantity through simple geometric operation on the change of the ribbon in the image pickup position before and after the rotation of the main shaft of the hydro-turbine. The rotating angle of the set can be converted according to the change size of the feature quantity. After the set is halted, an image processing program will collect an original image of the acquired image. After that, the image monitoring equipment will automatically collect the image of the main shaft of the hydro-turbine at a regular interval, and automatically compare with the original image. When the feature quantity change of the original image and the current image exceeds the set alarm threshold, an alarm signal is sent out automatically.

The pattern of the ribbon should meet the requirements of an image resolution firstly, and then a height of the ribbon should be completely displayed on the imaging plane, as shown in FIG. 2, in which \textcircled{1} and \textcircled{2} respectively represent two different color-coded patterns.

A circumference L of the main shaft 1 of the hydro-turbine is able to be expressed as: L=2πR.

A circular arc length L₀ corresponding to one degree of a central angle of the main shaft 1 of the hydro-turbine is able to be expressed as:

$${L}_{0} = \frac{2 π R}{360 °} .$$

The ribbon on the main shaft 1 of the hydro-turbine is composed of the adjacent isosceles right triangles with n periods, so a circular arc length L₁ corresponding to a ¼ period is:

$${L}_{1} = \frac{L}{4 n} = \frac{π R}{2 n} .$$

A vertical height H of the isosceles right triangle obtained according to a geometric relationship is:

$$H = {L}_{1} = \frac{π R}{2 n} .$$

A central angle θ corresponding to the ¼ period is:

$$θ = \frac{{L}_{1}}{{L}_{0}} = \frac{90 °}{n} .$$

In order to quickly recognize a length of the vertical height of the sawtooth wave collected at the image pickup position in the imaging plane before and after the rotation of the main shaft of the hydro-turbine, a value of the vertical height of the sawtooth wave needs to be calibrated in a y-axis direction of the image pickup position in the imaging plane from 0 to a maximum value. After the numerical calibration is completed, the actual height of the sawtooth wave at the image pickup position on the main shaft of the hydro-turbine can be automatically calculated according to the relationship between the calibration value and the actual height. According to the relationship of the relative motion, the image monitoring equipment can judge whether the set creeps by comparing the height value of the ribbon at the calibration position of the imaging plane after the hydro-turbine is halted and the height value of the ribbon at the calibration position of the imaging plane after the creep.

As shown in FIG. 2, the two adjacent isosceles right triangles form a period, and the ribbon consists of n periods, which are connected end to end.

In the case of a limited size of an imaging plane, division of a number of sawtooth waves on a ribbon is mainly affected by three factors: image resolution, measurement accuracy and a vertical height of the sawtooth waves, not exceeding a width of a camera. If the number of the sawtooth waves is too small, under a condition of a limited imaging size, a ratio of an actual graphic size to an imaging size will inevitably increases, and the measurement accuracy decreases, which cannot accurately reflect a small rotation amount of the set. If the number of the sawtooth waves is too large, the number of the images collected and processed by the image processing equipment in a unit time is required to increase, which requires a high image collection and processing ability. Secondly, the more the sawtooth waves are, the more difficult it is to install on site. Therefore, according to the characteristics that a frame rate of the images collected by the image monitoring equipment is very high at present and a rotating speed of the hydro-generator set is very small at the beginning of creep, a period of the images collected by the image monitoring equipment before and after the creep will not exceed ¼ by default, and the number of the sawtooth waves in the ribbon is hereby calculated and a creep alarm logic of the set is designed.

A national standard GB 11805-2008 Basic Specifications of Automatic Control Components (Devices) and Their Related System for Hydroturbine-generating Sets requires that a creep detection device shall output a pair of fault contacts at a rotating angle of 1.5°-2° when the main shaft rotates due to the water leakage in the guide vanes when the set is in the halt mode, so that the creep detection device can reliably detect when the set rotates at the rotating angle of 1.5°-2° in a ¼ period, and send an alarm signal, therefore, a central angle θ corresponding to the ¼ period shall be more than or equal to 2°, then

$$\frac{90 °}{n} \geq 2 \to n \leq 45 .$$

A radius of the main shaft of the hydro-turbine is defined as R, a vertical distance from an imaging lens on the camera to a circular section of the main shaft, that is, an object distance, is F, a distance from the imaging lens to the imaging plane, that is, an image distance, is f, ½ of a vertical maximum length of the imaging plane is h, a width of the camera is Z, according to an image forming principle:

$$\frac{F}{f} = \frac{Z}{h} \to Z = \frac{Fh}{f} .$$

According to the requirement that the vertical height H of an isosceles right triangle cannot exceed the with Z of the camera, it is concluded that:

$$H \leq Z \to \frac{π R}{2 n} \leq \frac{Fh}{f}$$

There is

$$F \geq \frac{π Rh}{2 nf} , \frac{h}{f}$$

is determined by the characteristics of the selected camera. Therefore, when the camera is selected, the vertical distance from the imaging lens to the arc section of the main shaft of the hydro-turbine should be not less than

$$\frac{π Rh}{2 nf} ,$$

so as to meet the requirement that the imaging can display the ribbon completely.

As shown in FIG. 2, the isosceles right triangle on the ribbon takes a vertical line with a vertex of the right angle downward as a symmetry line, and the isosceles triangles on both sides of the symmetry line are respectively painted with two different color codes.

A measuring method using the system for measuring the creep of the hydro-generator by using the image monitoring, comprises the measuring steps of:
step 1, after halting a set, taking the image of the ribbon by the camera 2 and imaging on the imaging plane 3 at the back end, and then continuing to image the ribbon according to a frame rate of the image monitoring equipment connected to the camera 2, and firstly carrying out basic calculation:
a circumference L of the main shaft 1 of the hydro-turbine being expressed as: L=2πR
a circular arc length L₀ corresponding to one degree of a central angle of the main shaft (1) of the hydro-turbine being expressed as:

$${L}_{0} = \frac{2 π R}{360 °}$$

the ribbon on the main shaft 1 of the hydro-turbine is composed of the adjacent isosceles right triangles with n periods, so a circular arc length L₁ corresponding to a ¼ period being:

$${L}_{1} = \frac{L}{4 n} = \frac{π R}{2 n}$$

a vertical height H of the isosceles right triangle obtained according to a geometric relationship being:

$$H = {L}_{1} = \frac{π R}{2 n}$$

a central angle θ corresponding to the ¼ period being:

$$θ = \frac{{L}_{1}}{{L}_{0}} = \frac{90 °}{n} ;$$

step 2, defining the image when the set is halted as a time TO, and a subsequent imaging time as a time T1, a corresponding Y-axis height of the image at the time TO at the image pickup position being H0, the corresponding Y-axis height on the main shaft 1 of the hydro-turbine at the image pickup position at the time TO being H0′, the corresponding Y-axis height of the image at the time T1 at the image pickup position being H1, and the corresponding Y-axis height on the main shaft 1 of the hydro-turbine at the image pickup position at the time T1 being H1′, according to an imaging principle:

$$\frac{F}{f} = \frac{H {0}^{′}}{H 0} = \frac{H {1}^{′}}{H 1}$$

obtaining

$$H {0}^{′} = \frac{F}{f} \times H 0 , H {1}^{′} \frac{F}{f} \times H 1 ;$$

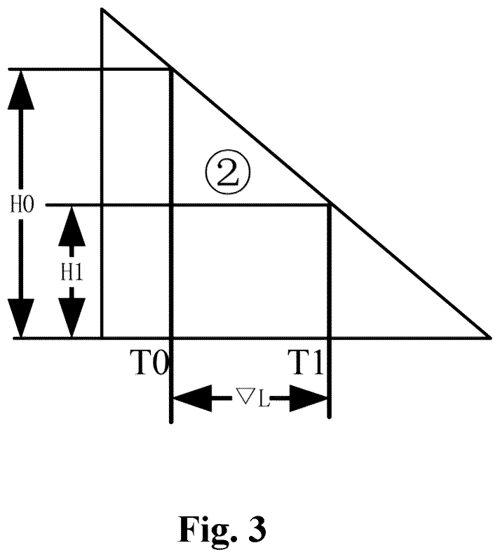

an arc length corresponding to a rotating central angle of the main shaft of the hydro-turbine being ∇L from the time T0 to the time T1, then:
entering into step 3 when the color codes of the image picked up at the image pickup position of the image plane at the time TO and the time T1 being the same;
entering into step 4 when the color codes of the image picked up at the image pickup position of the image plane at the time TO and the time T1 being different, and directions being different; and
entering into step 5 when the color codes of the image picked up at the image pickup position of the image plane at the time TO and the time T1 being different, but the directions being the same;
step 3, as shown in FIG. 3, when the color codes of the image picked up at the image pickup position of the image plane at the time TO and the time T1 being the same, after the set being halted, the color code of the image collected by the image monitoring equipment at the time T0 being [symbol] , and the color code of the image collected by the image monitoring equipment at the time T1 being still [symbol] , then

$$∇ L = \vert H {1}^{′} - H {0}^{′} \vert$$

calculating a rotating angle ∇θ of the hydro-turbine according to the circular arc length L₀ corresponding to one degree of the central angle of the main shaft 1 of the hydro-turbine:

$$∇ θ = \frac{∇ L}{{L}_{0}} = \frac{\vert H {1}^{′} - H {0}^{′} \vert}{π R} \times 180 ° entering into step 6 ;$$

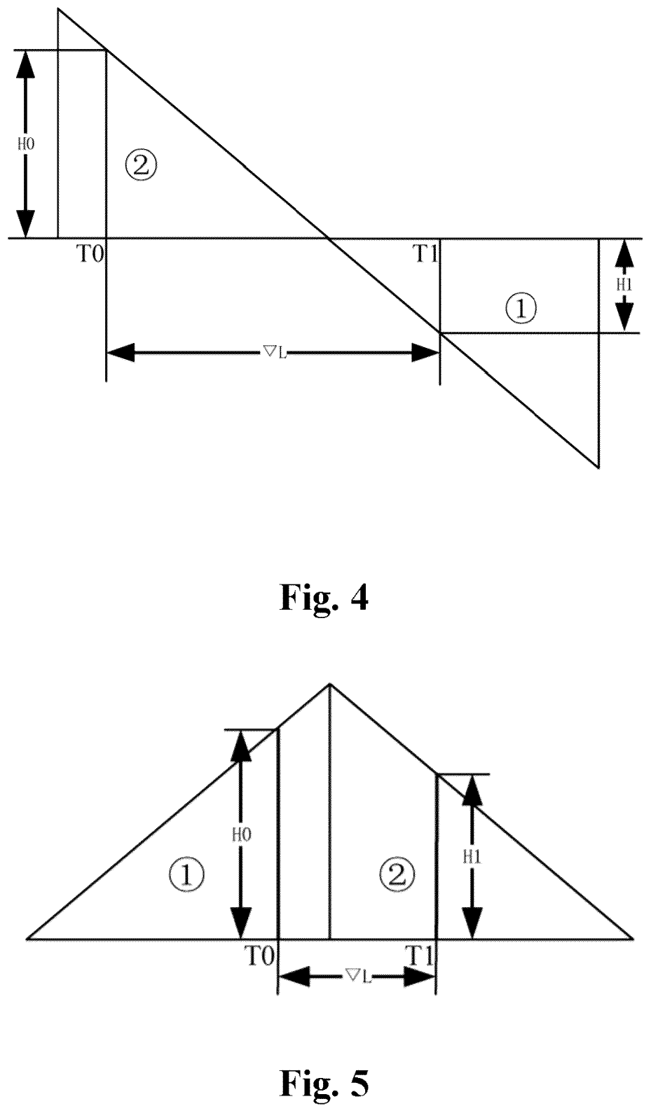

step 4, as shown in FIG. 4, when the color codes of the image picked up at the image pickup position of the image plane at the time TO and the time T1 being different, and the directions being different, entering into step 4; after the set being halted, the color code of the image collected by the image monitoring equipment at the time TO being [symbol] , and the color code of the image collected by the image monitoring equipment at the time T1 being still [symbol] , and [symbol] and [symbol] being respectively on an upper side and a lower side of the horizontal center line, wherein:

$$∇ L = H {0}^{′} + H {1}^{′} ;$$

calculating the rotating angle ∇θ of the hydro-turbine according to the circular arc length L₀ corresponding to one degree of the central angle of the main shaft 1 of the hydro-turbine:

$$∇ θ = \frac{∇ L}{{L}_{0}} = \frac{H {0}^{′} + H {1}^{′}}{π R} \times 180 ° entering into step 6 ;$$

step 5, when the color codes of the image picked up at the image pickup position of the image plane at the time TO and the time T1 being different, but the directions being the same, after the set being halted, the color code of the image collected by the image monitoring equipment at the time TO being [symbol] , and the color code of the image collected by the image monitoring equipment at the time T1 being still [symbol] , and [symbol] and [symbol] being respectively on the upper side and the lower side of the horizontal center line,

$$∇ L = 2 H - H {0}^{′} - H {1}^{′} ;$$

calculating the rotating angle ∇θ of the hydro-turbine according to the circular arc length L₀ corresponding to one degree of the central angle of the main shaft (1) of the hydro-turbine:

$$∇ θ = \frac{∇ L}{{L}_{0}} = \frac{2 H - H {0}^{′} - H {1}^{′}}{π R} \times 180 ° entering into step 6 ;$$

step 6, comparing ∇θ with a set creep allowable threshold, and if exceeding the threshold, then outputting a creep alarm of the set.

According to an inertia characteristic of the hydro-generator set, the rotating speed is very small at the beginning of the creep. At present, the frame rate of the image monitoring equipment can completely capture the graph on the main shaft of the hydro-generator set after the creep. According to the corresponding relationship between the vertical height of sawtooth wave from 0 to the maximum and a pixel value of the image on the y axis of the imaging plane, through a designated algorithm, the creep angle of the set in the ¼ period can be completely calculated, and the alarm accuracy can also meet the national standard GB 11805-2008.

What is claimed is:

1. A system for measuring creep of a hydro-generator by using image monitoring, wherein a circle of “sawtooth waveform” ribbon is arranged around an outer wall of a main shaft (1) of a hydro-turbine, a “sawtooth waveform” of the ribbon is formed by arranging isosceles right triangles, a hypotenuse of the isosceles right triangle forms a straight line segment, right angles of the adjacent isosceles right triangles are respectively on an upper side and a lower side of the hypotenuse, the isosceles right triangle is painted with a color code,
a camera (2) is arranged directly opposite to the main shaft (1) of the hydro-turbine, a horizontal center of the camera (2) is flush with the straight line segment formed by the hypotenuse of the isosceles right triangle, the camera (2) takes an image of the ribbon and images on an imaging plane (3) at a back end, and whether the hydro-generator creeps is judged according to a vertical height change of the ribbon image subsequently taken at a specific image pickup position and when the main shaft (1) of the hydro-turbine stops.

2. The system for measuring the creep of the hydro-generator by using the image monitoring according to claim 1, wherein two adjacent isosceles right triangles form a period, and the ribbon consists of n periods, which are connected end to end.

3. The system for measuring the creep of the hydro-generator by using the image monitoring according to claim 2, wherein n≤45.

4. The system for measuring the creep of the hydro-generator by using the image monitoring according to claim 3, wherein a radius of the main shaft (1) of the hydro-turbine is defined as R, a vertical distance from an imaging lens on the camera (2) to a circular section of the main shaft (1), that is, an object distance, is F, a distance from the imaging lens to the imaging plane (3), that is, an image distance, is f, ½ of a vertical maximum length of the imaging plane (3) is h, wherein
$$F \geq \frac{π Rh}{2 nf} .$$

5. The system for measuring the creep of the hydro-generator by using the image monitoring according to claim 4, wherein the isosceles right triangle on the ribbon takes a vertical line with a vertex of the right angle downward as a symmetry line, and the isosceles triangles on both sides of the symmetry line are respectively painted with two different color codes.

6. A measuring method using the system for measuring the creep of the hydro-generator by using the image monitoring according to claim 5, comprising the following steps:
step 1, after halting a set, taking the image of the ribbon by the camera (2) and imaging on the imaging plane (3) at the back end, and then continuing to image the ribbon according to a frame rate of image monitoring equipment connected to the camera (2), and firstly carrying out basic calculation:
a circumference L of the main shaft (1) of the hydro-turbine being expressed as: L=2πR
a circular arc length L₀ corresponding to one degree of a central angle of the main shaft (1) of the hydro-turbine being expressed as:
$${L}_{0} = \frac{2 π R}{360 °}$$
the ribbon on the main shaft (1) of the hydro-turbine being composed of the adjacent isosceles right triangles with n periods, so a circular arc length L₁ corresponding to a ¼ period being:
$${L}_{1} = \frac{L}{4 n} = \frac{π R}{2 n}$$
a vertical height H of the isosceles right triangle obtained according to a geometric relationship being:
$$H = {L}_{1} = \frac{π R}{2 n}$$
a central angle θ corresponding to the ¼ period being:
$$θ = \frac{{L}_{1}}{{L}_{0}} = \frac{90 °}{n} ,$$
step 2, defining an imaging time when the set is halted as a time TO, and a subsequent imaging time as a time T1, a corresponding y-axis direction height of the image at the time TO at the image pickup position being H0, the corresponding y-axis direction height on the main shaft (1) of the hydro-turbine at the image pickup position at the time TO being H0′, the corresponding y-axis direction height of the image at the time T1 at the image pickup position being H1, and the corresponding y-axis direction height on the main shaft (1) of the hydro-turbine at the image pickup position at the time T1 being H1′, according to an imaging principle:
$$\frac{F}{f} = \frac{H {0}^{′}}{H {0}^{′}} = \frac{H {1}^{′}}{H 1}$$
obtaining
$$H {0}^{′} = \frac{F}{f} \times H 0 , H {1}^{′} = \frac{F}{f} \times H 1 ;$$
an arc length corresponding to a rotating central angle of the main shaft of the hydro-turbine being ∇L from the time T0 to the time T1, then:
entering into step 3 when the color codes of the image picked up at the image pickup position of the image plane at the time TO and the time T1 being the same;
entering into step 4 when the color codes of the image picked up at the image pickup position of the image plane at the time TO and the time T1 being different, and directions being different; and
entering into step 5 when the color codes of the image picked up at the image pickup position of the image plane at the time TO and the time T1 being different, but the directions being the same;
step 3, when the color codes of the image picked up at the image pickup position of the image plane at the time TO and the time T1 being the same,
$$∇ L = \vert H {1}^{′} - H {0}^{′} \vert ;$$
calculating a rotating angle ∇θ of the hydro-turbine according to the circular arc length L₀ corresponding to one degree of the central angle of the main shaft (1) of the hydro-turbine:
$$∇ θ = \frac{∇ L}{{L}_{0}} = \frac{\vert H {1}^{′} - H {0}^{′} \vert}{π R} \times 180 ° entering into step 6 ;$$
step 4, when the color codes of the image picked up at the image pickup position of the image plane at the time TO and the time T1 being different, and the directions being different,
$$∇ L = H {0}^{′} + H {1}^{′} ;$$
calculating the rotating angle ∇θ of the hydro-turbine according to the circular arc length L₀ corresponding to one degree of the central angle of the main shaft (1) of the hydro-turbine:
$$∇ θ = \frac{∇ L}{{L}_{0}} = \frac{H {0}^{′} - H {1}^{′}}{π R} \times 180 ° entering into step 6 ;$$
step 5, when the color codes of the image picked up at the image pickup position of the image plane at the time T0 and the time T1 being different, and the directions being different,
$$∇ L = 2 H - H {0}^{′} - H {1}^{′} ;$$
calculating the rotating angle ∇θ of the hydro-turbine according to the circular arc length L₀ corresponding to one degree of the central angle of the main shaft (1) of the hydro-turbine:
$$∇ θ = \frac{∇ L}{{L}_{0}} = \frac{2 H - H {0}^{′} - H {1}^{′}}{π R} \times 180 ° entering into step 6 ;$$
step 6, comparing ∇θ with a set creep allowable threshold, and if exceeding the threshold, then outputting a creep alarm of the set.
